(19) United States
(12) Patent Application Publication
(10) Pub. No.: US 2013/0130909 A1
(43) Pub. Date: May 23, 2013

(54) DCMU RESISTANCE IN NANNOCHLOROPSIS

(71) Applicants: Bertrand Vick, Berkeley, CA (US); Shaun Bailey, Los Altos, CA (US)

(72) Inventors: Bertrand Vick, Berkeley, CA (US); Shaun Bailey, Los Altos, CA (US); Jeffrey Moseley, Redwood City, CA (US)

(21) Appl. No.: 13/491,537

(22) Filed: Jun. 7, 2012

Related U.S. Application Data
(60) Provisional application No. 61/494,330, filed on Jun. 7, 2011.

(51) Int. Cl. A01N 47/30

(52) U.S. Cl. CPC A01N 47/30
USPC 504/330

(57) ABSTRACT

Provided herein are exemplary methods for controlling a density of algae growing in an aquatic environment. Some exemplary methods include applying an effective amount of 3-(3,4-dichlorophenyl)-1,1-dimethylurea (DCMU) to the density of algae growing in the aquatic environment, wherein the algae includes genus Nannochloropsis. The algae may also include algae of genus Tetraselmis and/or genus Chlorella. Applying the effective amount may result in an approximate concentration of between 100 nanomolar to 1500 nanomolar DCMU in the aquatic environment. Further, the aquatic environment may include seawater, freshwater, or mixtures thereof.

### CROSS-REFERENCE TO RELATED APPLICATIONS

The present application claims the benefit and priority of U.S. Provisional Patent Application Ser. No. 61/494,330 filed on Jun. 7, 2011, titled “DCMU Resistance in Nannochloropsis,” which is hereby incorporated by reference.

### BACKGROUND OF THE INVENTION

### Field of the Invention

This invention relates to biochemistry, and more specifically, to algal cultivation.

### SUMMARY OF THE INVENTION

Provided herein are exemplary methods for controlling a density of algae growing in an aquatic environment. Some exemplary methods include applying an effective amount of 3-(3,4-dichlorophenyl)-1,1-dimethylurea (DCMU) to the density of algae growing in the aquatic environment, wherein the algae includes genus Nannochloropsis. The algae may also include algae of genus Tetraselmis and/or genus Chlorella. Applying the effective amount may result in an approximate concentration of between 100 nanomolar to 1500 nanomolar DCMU in the aquatic environment. Further, the aquatic environment may include seawater, freshwater, or mixtures thereof.

Further exemplary methods for controlling a density of algae growing in an aquatic environment may include applying an effective amount of DCMU to the density of algae growing in the aquatic environment, wherein the algae includes genus Nannochloropsis, and wherein applying the effective amount results in an approximate concentration of between 100 nanomolar to 1500 nanomolar DCMU in the aquatic environment, and wherein the effective amount inhibits Nannochloropsis growth by no more than approximately twenty percent.

Other exemplary methods for controlling a density of algae growing in an aquatic environment may include applying an effective amount of DCMU to the density of algae growing in the aquatic environment, wherein the algae includes genus Nannochloropsis, and wherein applying the effective amount results in an approximate concentration of between 0.38 micromolar to 1.55 micromolar DCMU in the aquatic environment, and wherein the effective amount inhibits Nannochloropsis growth by no more than approximately twenty percent, and wherein the effective amount of DCMU inhibits Tetraselmis growth by greater than approximately 75 percent.

### BRIEF DESCRIPTION OF THE DRAWINGS

FIG. 1 shows the application of 50 micromolar quanta m⁻² s⁻¹ actinic light on algae of genus Nannochloropsis (“W2”).

FIG. 2 shows the application of 50 micromolar quanta m⁻² s⁻¹ actinic light on algae of genus Chlorella.

FIG. 3 is a graph of relative fluorescence rise versus percentage contaminating species for the algae of genus Chlorella as referred to in FIG. 2.

FIG. 4 shows the genetic basis for the higher degree of tolerance to DCMU in Nannochloropsis (“W2”).

FIG. 5 shows a flow chart for an exemplary method of applying an effective amount of DCMU to a density of algae growing in an aquatic environment.

FIG. 6 shows the presence of algal genus Tetraselmis in six 1 million liter open pond raceway systems.

### DETAILED DESCRIPTION OF THE INVENTION

As evidenced herein, the inventors have discovered and innovated systems and methods to exploit the high resistance of algal genus Nannochloropsis to 3-(3,4-dichlorophenyl)-1,1-dimethylurea (“DCMU”). They have invented systems and methods for keeping DCMU sensitive invasive phototrophs out of various growth systems. Additionally, the inventors have quantified the extent to which cultures are contaminated with invasive algal species, including demonstrating that there is a linear relationship between the fraction of invasive species in a culture and the fluorescence rise under low actinic irradiance in the presence of low levels of DCMU. Further, the inventors have identified the genetic basis for the higher degree of tolerance of Nannochloropsis to DCMU.

3-(3,4-dichlorophenyl)-1,1-dimethylurea (“DCMU”) is a broad range plant herbicide effective against most known oxygenic phototrophs. Its mode of action is to inhibit photosynthetic electron transport by binding to the QB binding pocket on photosystem II (“PSII”). Once bound, DCMU prevents the binding of plastoquinone, thereby preventing electron transport away from PSII.

Typically, DCMU is instantaneously efficacious at concentrations in the 0.1 micromolar to 50 micromolar range. The inventors herein discovered that algae of the genus Nannochloropsis, however, generally requires higher concentrations and relatively lengthy incubation periods for the effects of DCMU to take place. At a concentration of 100 nanomolar, Nannochloropsis appears to be completely resistant to DCMU following a 24 hour incubation period.

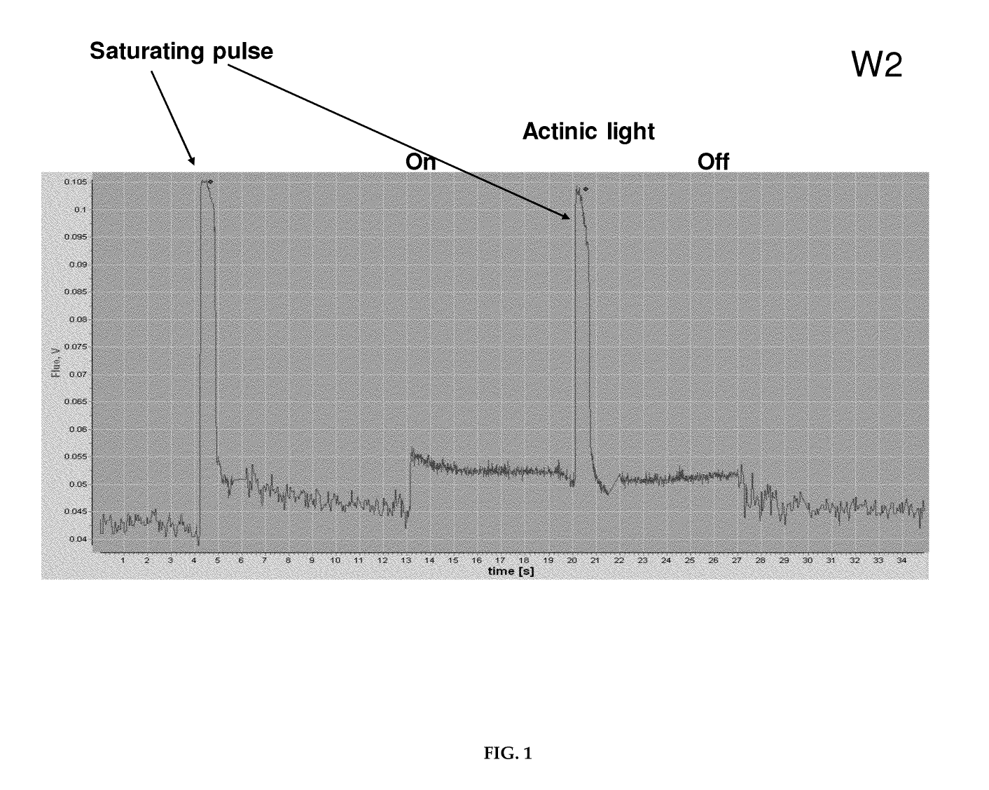

FIG. 1 shows the application of 50 micromolar quanta m⁻² s⁻¹ actinic light on algae of genus Nannochloropsis (“W2”).

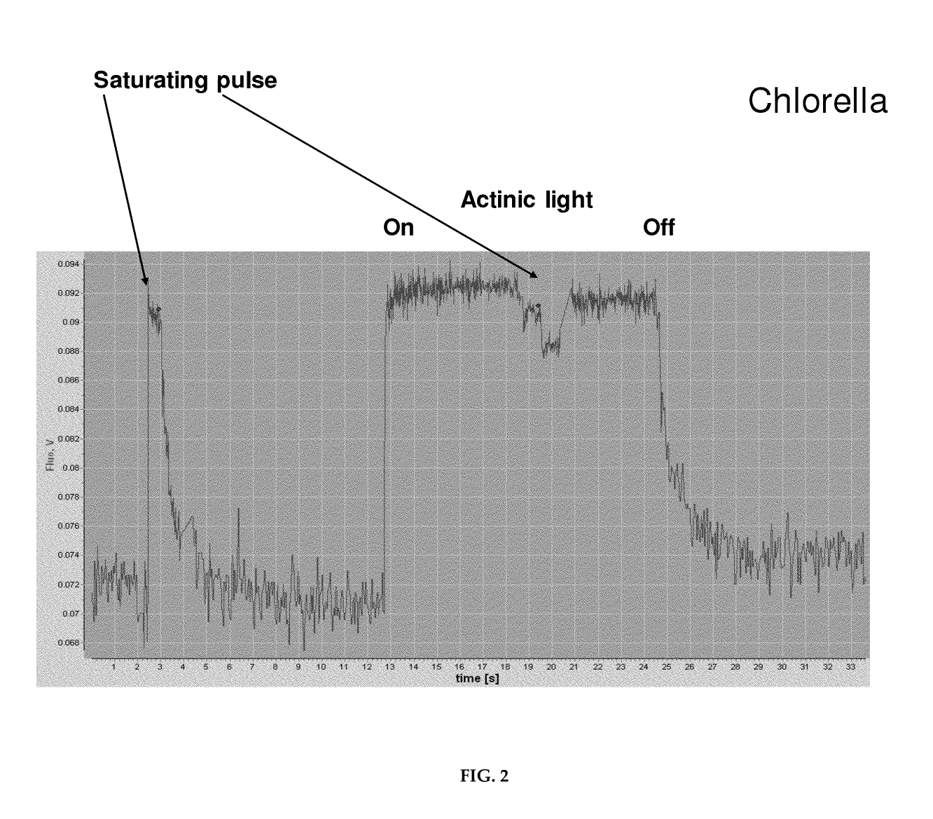

FIG. 2 shows the application of 50 micromolar quanta m⁻² s⁻¹ actinic light on algae of genus Chlorella.

In Chlorella, which the inventors isolated from an invaded pond at a Mexico field site, DCMU had a strong herbicidal effect at a concentration of 100 nanomolar. This is demonstrated in FIG. 2, in which the 50 micromolar quanta m⁻² s⁻¹ actinic light completely closes PSII reaction centers in Chlorella, but barely has an effect on the Nannochloropsis, as shown in FIG. 1.

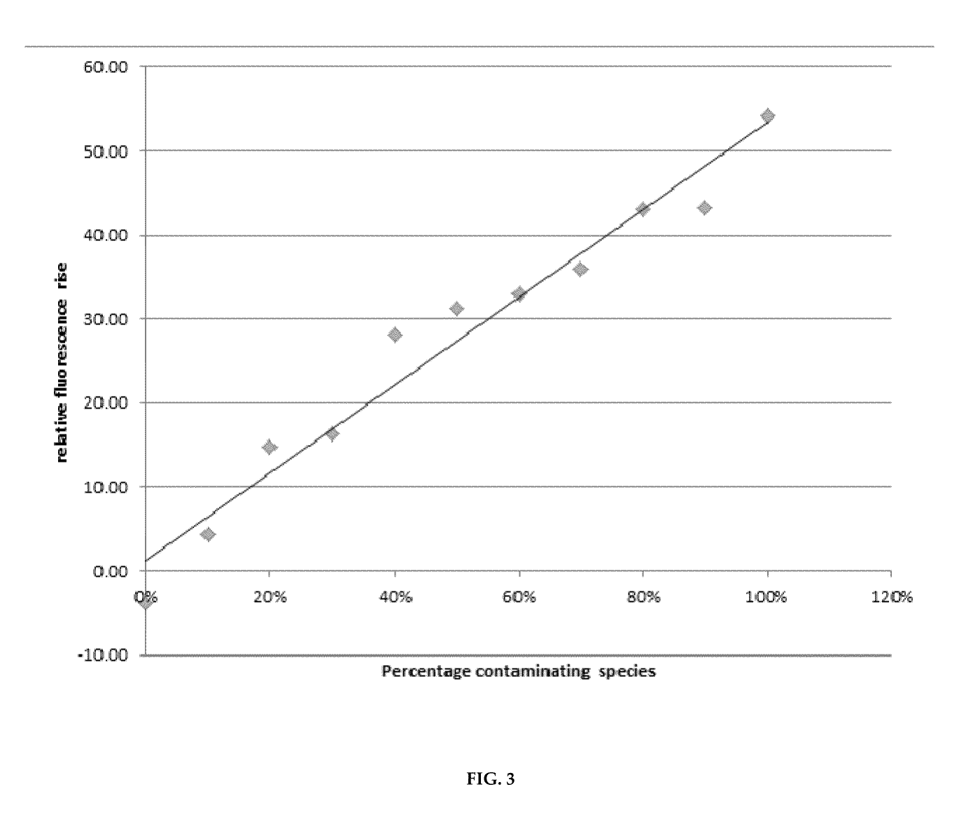

FIG. 3 (“FIG. 3”) is a graph of relative fluorescence rise versus percentage contaminating species for the algae of genus Chlorella as referred to in FIG. 2. In FIG. 3, the impact of the actinic light is seen in the relative fluorescence rise to the maximum fluorescence yield observed during an intense saturating pulse, during the low level actinic light treatment for the Chlorella culture, the same rise being absent from the Nannochloropsis culture. Here, as shown in FIG. 3, the inventors observed a linear relationship between the extent of contaminating algae and the fluorescence rise.

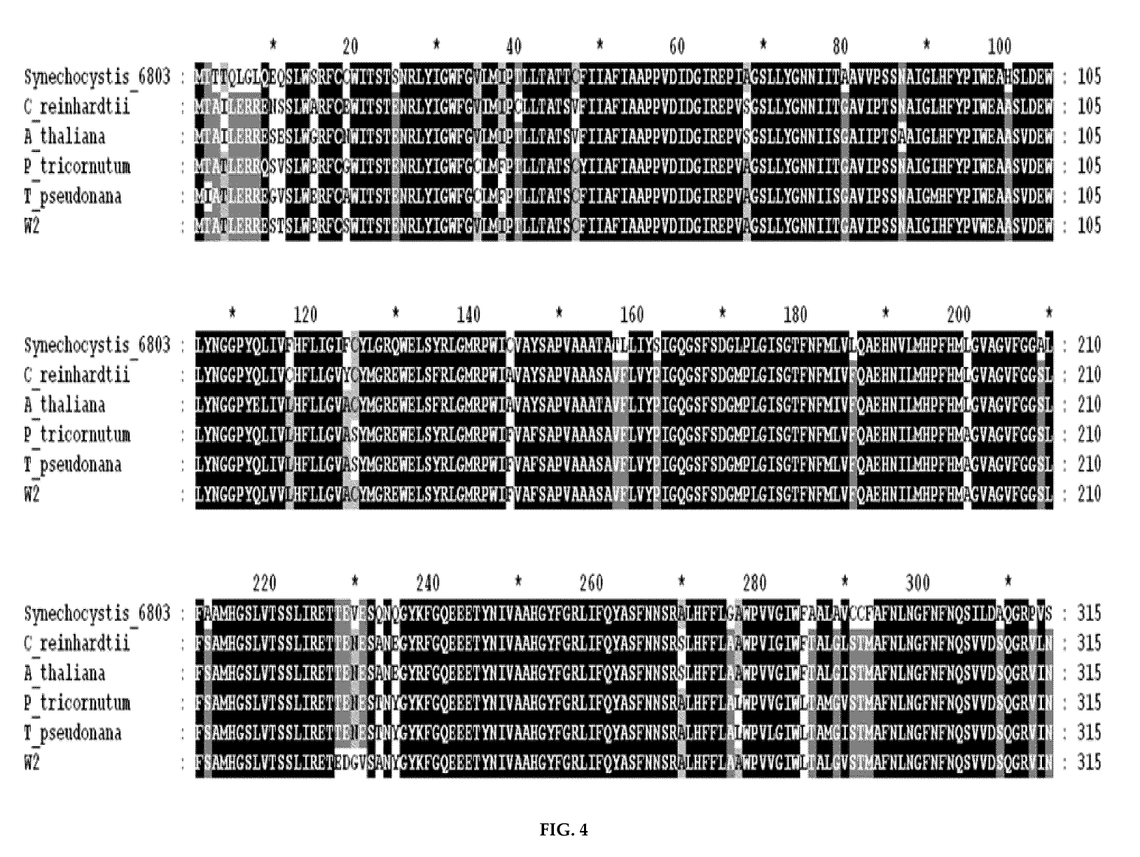

FIG. 4 (“FIG. 4”) shows the genetic basis for the higher degree of tolerance to DCMU in Nannochloropsis (“W2”). Specifically, FIG. 4 shows the amino acid sequence for the D1 polypeptide of PSII in Nannochloropsis in comparison to other organisms. This protein is responsible for binding to plastoquinone and therefore to DCMU. As shown in FIG. 4, the D1 polypeptide is very highly conserved at the amino acid level across all oxygenic phototrophs, including higher plants, algae and cyanobacteria. When the Nannochloropsis peptide sequence is aligned against the D1 sequences from other phototrophs, a four amino acid substitution (i.e. EDGV) is apparent at positions 227-231. This region is known to be in the QB binding pocket of the D1 polypeptide.

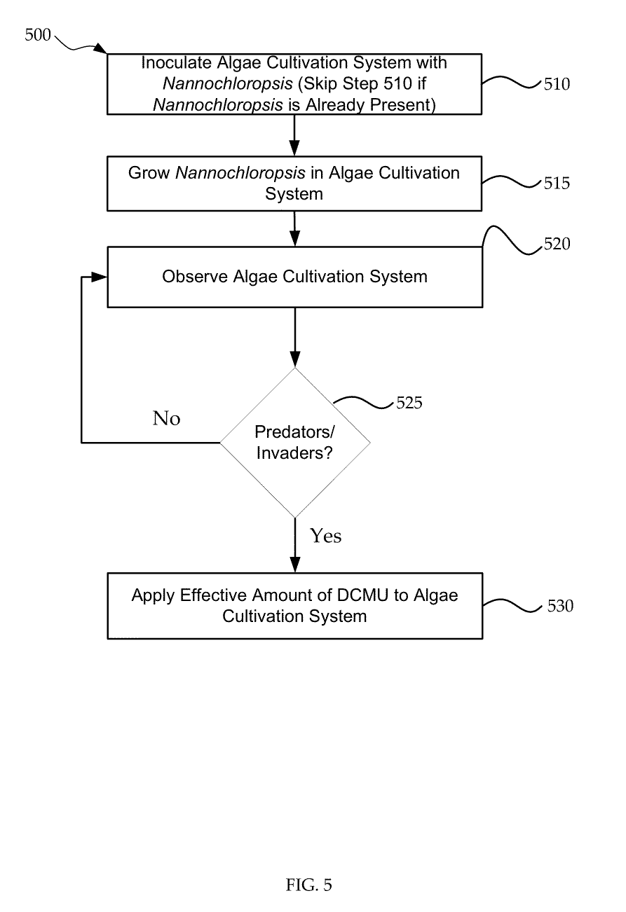

FIG. 5 shows a flow chart for an exemplary method 500 of applying an effective amount of DCMU to a density of algae growing in an aquatic environment.

At step 510, the aquatic environment or algae cultivation system is inoculated with Nannochloropsis (note: step 510 may be skipped if Nannochloropsis is already present, e.g., an existing pond, vessel, photobioreactor, etc. with Nannochloropsis). According to various exemplary embodiments, the algae cultivation system may be an open pond, a closed pond and/or a photobioreactor. Further, the Nannochloropsis culture may comprise one or more strains of the genus Nannochloropsis. Outdoor Nannochloropsis cultures may be started with the addition of an initial, small amount of pure unialgal (virtually free from unwanted contaminant organisms) Nannochloropsis. Such an inoculum may be generated in a controlled environment, such as in a laboratory or in a closed system.

At step 515, the Nannochloropsis is grown in the algae cultivation system. According to various embodiments, the Nannochloropsis culture may require light (natural or artificially supplied) for growth, as well as nutrients. Other parameters such as pH should be within acceptable ranges. The basic elements typically required for Nannochloropsis growth may include carbon, oxygen, hydrogen, nitrogen, sulfur, phosphorous, potassium, magnesium, iron and traces of several other elements.

The required nutrients for Nannochloropsis growth may be contained in the water, supplied subsequently in dilution waters, or supplied independently of the dilution waters, in a concentration sufficient to allow Nannochloropsis to grow and reach a desired final density. The amount of nutrients needed to yield a prescribed Nannochloropsis density may be determined by the cell quota for that nutrient. That is, by the percent of the algal dry mass that is comprised of the element contained in the nutrient. The inverse of the cell quota is called the algae growth potential for that nutrient or element. For instance, if the desired final density is 1 gram/liter and the Nannochloropsis strain under consideration contains ten percent (10%) nitrogen in its biomass (i.e., a cell quota of 0.1), then the initial concentration of the atomic nitrogen in the culture should be at least 0.1 gram/liter. The same calculation may be performed for all nutrients to establish their initial concentration in the culture.

In various embodiments, a wide variety of systems utilized for the mass culturing of algae may be optimized for Nannochloropsis growth. The time-averaged light intensity to which Nannochloropsis may be exposed may be adjusted by changes in the mixing intensity and in the optical depth of the apparatus. In panel-shaped modular photobioreactors, the latter may be performed by controlling the distance between two consecutive panels. On the other hand, the optical depth in open ponds may be the depth of the pond. Similarly, the temperature in closed photobioreactors may be precisely controlled by means of indirect heat exchange. In open ponds, the temperature may be controlled by adjusting culture depth. After two to ten days, Nannochloropsis may reach a productive operating density depending on light intensity, temperature, and the starting inoculum size.

Once the Nannochloropsis is grown to a desired density, according to some embodiments, it may either be removed (and a new culture may be started with a new inoculum), or it may be diluted according to a prescribed schedule or rate. In the first case, culturing may be performed in a batch mode and may require frequent re-inoculation. In the latter case, culturing may be performed in a continuous or a semi-continuous fashion, depending on the way the dilution is performed. For example, assuming that the desired dilution rate is fifty percent (50%) per day of the culture volume, culture dilution may take place in one or more of several techniques. Culture dilution may take place continuously over the day (or over part of the day) at a constant or at a variable rate. Culture dilution may alternatively take place semi-continuously once a day (i.e., fifty percent (50%) of the culture is removed and replaced with a new growth medium in a short period of time every day); semi-continuously twice a day (i.e., twenty-five percent (25%) of the culture is removed each time at two different times every day); or semi-continuously at any other desired frequency over the day. In some embodiments, culture dilution may comprise removing the Nannochloropsis culture medium from the growth system—whether this is in an open pond or in a closed photobioreactor—and replacing this portion with fresh medium, which may contain all of the nutrients in the quantity sufficient for the growth of the Nannochloropsis between two consecutive dilutions.

At step 520, after the algae cultivation system is inoculated with Nannochloropsis and/or the Nannochloropsis is grown to a desired density, the algae cultivation system may be observed (e.g., visually with a naked eye, microscopically, and/or analytically, including the taking and analysis of samples). Such observations or sampling may take place every minute, hourly, daily, every other day, three times a week, weekly, and/or on any other suitable basis. In connection with this process, one or more determinations may be made as to a relative level or amount of predators and/or invaders in comparison to an actual and/or desired density or dominance of Nannochloropsis.

At step 525, a determination is made whether Nannochloropsis dominance in the algae cultivation system is being challenged by predators and/or invaders. Based upon this determination, a decision may be made whether to apply an effective amount of DCMU. If the level or amount of predators and/or invaders is less than a prescribed level, the algae cultivation system may continue to be observed without the application of DCMU.

At step 530, if the level or amount of predators and/or invaders exceeds an actual or desired level, an effective amount of DCMU may be applied to the density of algae growing in the algae cultivation system. One exemplary method is applying an effective amount of 3-(3,4-dichlorophenyl)-1,1-dimethylurea (DCMU) to the density of algae growing in the aquatic environment, wherein the algae includes genus Nannochloropsis. The algae may also include algae of genus Tetraselmis and/or genus Chlorella. Applying the effective amount may result in an approximate concentration of between 100 nanomolar to 1500 nanomolar DCMU in the aquatic environment. Further, the aquatic environment may include seawater, freshwater, or mixtures thereof.

Further exemplary methods for controlling a density of algae growing in an aquatic environment may include applying an effective amount of DCMU to the density of algae growing in the aquatic environment, wherein the algae includes genus Nannochloropsis, and wherein applying the effective amount results in an approximate concentration of between 100 nanomolar to 1500 nanomolar DCMU in the aquatic environment, and wherein the effective amount inhibits Nannochloropsis growth by no more than approximately twenty percent.

Other exemplary methods for controlling a density of algae growing in an aquatic environment may include applying an effective amount of DCMU to the density of algae growing in the aquatic environment, wherein the algae includes genus Nannochloropsis, and wherein applying the effective amount results in an approximate concentration of between 0.38 micromolar to 1.55 micromolar DCMU in the aquatic environment, and wherein the effective amount inhibits Nannochloropsis growth by no more than approximately twenty percent, and wherein the effective amount of DCMU inhibits Tetraselmis growth by greater than approximately 75 percent.

Generally, if the density or dominance of Nannochloropsis increases, while the presence of the predators and/or invaders decreases, one may assume the application of DCMU was effective (i.e. an effective protocol).

Various embodiments may include a system for applying an effective amount of DCMU to a density of algae growing in an aquatic environment. The system may include a communications interface, a computer readable storage medium, and a processor. The computer readable storage medium may further comprise instructions for execution by the processor. The instructions for execution by the processor cause the processor to apply an effective amount of DCMU to a density of algae growing in an algae cultivation system. The processor may execute other instructions described herein and remain within the scope of contemplated embodiments.

Another embodiment may include a computer readable storage medium having a computer readable code for operating a computer to apply an effective amount of DCMU to a density of algae growing in an algae cultivation system. Examples of computer readable storage medium may include discs, memory cards, servers and/or computer discs. Instructions may be retrieved and executed by a processor. Some examples of instructions include software, program code, and firmware. Instructions are generally operational when executed by the processor to direct the processor to operate in accord with embodiments of the invention. Although various modules may be configured to perform some or all of the various steps described herein, fewer or more modules may be provided and still fall within the scope of various embodiments.

### EXAMPLE ONE

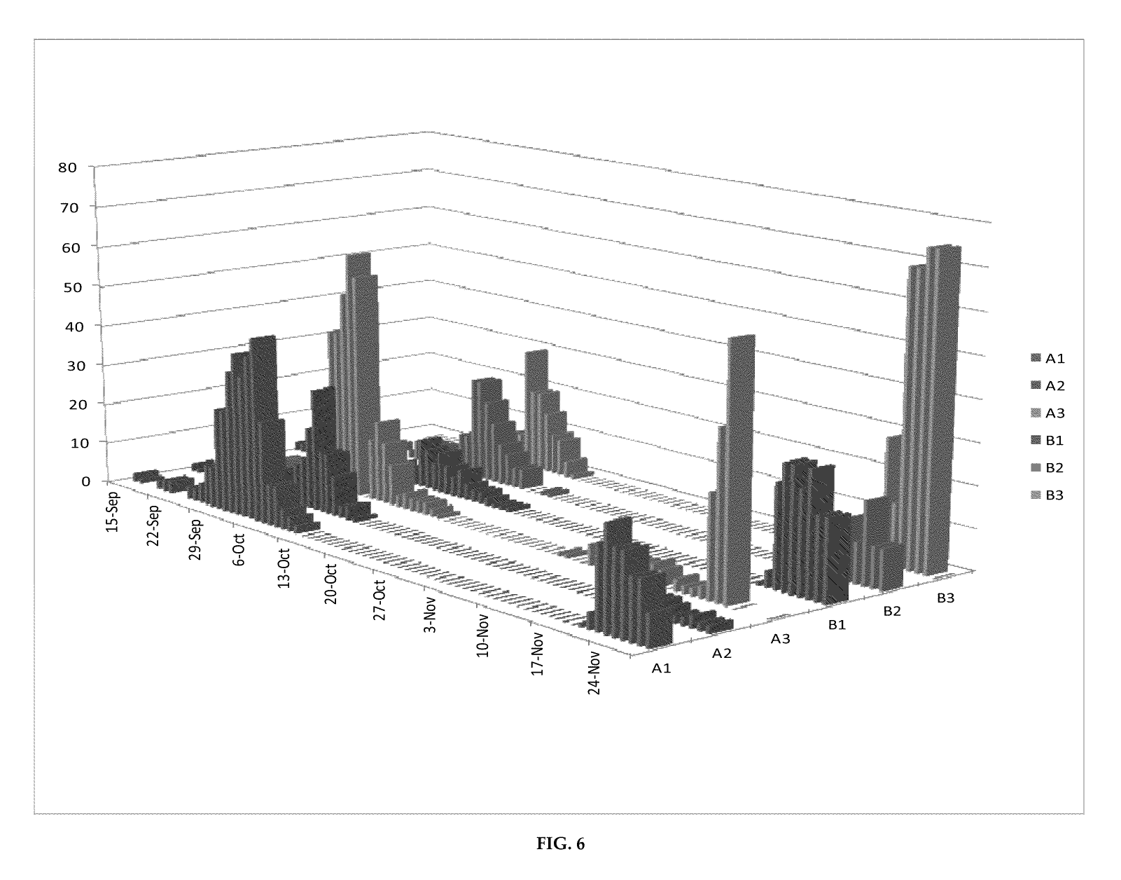

FIG. 6 (“FIG. 6”) shows the presence of algal genus Tetraselmis in six 1 million liter open pond raceway systems. The inventors utilized commercially available DCMU at a field research site to kill the persistent weed algae of genus Tetraselmis. DCMU was administered to six 1 million liter open pond raceway systems wherein Nannochloropis cultures were cultivated at a density of approximately 270 milligrams per liter. Tetraselmis invasion in the ponds is shown in FIG. 6, and is quantified in Table 2 as a percentage of mass. The higher the percentage of mass, the higher the Tetraselmis invasion. The six 1 million liter open pond raceway systems are denoted in FIG. 6, Table 1, and Table 2 as Pond A1, Pond A2, Pond A3, Pond B1, Pond B2, and Pond B3. There were two Tetraselmis “outbreaks” observed during this time period, and Table 1 shows the levels (in grams) of DCMU that were effective in killing most, if not all of, the offending Tetraselmis:

TABLE 1

| | Outbreak 1 | Outbreak 2 |
|---|---|---|
| Pond A1 | 400 | 200 |
| Pond A2 | 200 | 200 |
| Pond A3 | 100 | N/A; Pond Abandoned |
| Pond B1 | 200 | 160 |
| Pond B2 | 200 | 160 |
| Pond B3 | 200 | 360; Pond dumped |

Consequently, as little as 100 grams, and as much as 400 grams, were needed. The commercial DCMU source was 90% DCMU by mass, so 90 grams and 360 grams effective amounts of DCMU (M.W. 233 amu) in 1 million liters of volume converts to DCMU concentrations of 0.38 micromolar and 1.55 micromolar, respectively.

TABLE 2

| | Pond | Pond | Pond | Pond | Pond | Pond |
|---|---|---|---|---|---|---|
| Date | A1 | A2 | A3 | B1 | B2 | B3 |
| 15-Sep | | | | 2 | 1 | |
| 16-Sep | 2 | 2 | | 2 | 2 | |
| 17-Sep | 1 | 1 | | 2 | 2 | |
| 18-Sep | | | | | | |
| 19-Sep | | 1 | 1 | 2 | 2 | 0 |
| 20-Sep | 2 | 1 | 2 | 2 | 2 | 0 |
| 21-Sep | 3 | 2 | 3 | 2 | 2 | 0 |
| 22-Sep | 3 | 2 | 3 | 2 | 2 | 0 |
| 23-Sep | | | | | | |
| 24-Sep | | | | | | |
| 25-Sep | 3 | 2 | 3 | 4 | 2 | 0 |
| 26-Sep | 3 | 3 | 7 | 8 | 5 | 0 |
| 27-Sep | 5 | 2 | 8 | 1 | 5 | 0 |
| 28-Sep | 10 | 3 | 10 | 5 | 5 | 0 |
| 29-Sep | 10 | 5 | 12 | 6 | 5 | 0 |
| 30-Sep | 25 | 7 | 40 | 3 | | 2 |
| 1-Oct | 25 | 7 | 40 | 4 | 6 | 3 |
| 2-Oct | 35 | 4 | 50 | 2 | 4 | 3 |
| 3-Oct | 40 | 10 | 60 | 4 | 10 | 8 |
| 4-Oct | 35 | 12 | 55 D | 4 | 10 | 8 |
| 5-Oct | 40 | 20 | 10 | 12 | 25 | 30 |
| 6-Oct | 45 | 30 | 15 | 10 | 25 | 20 |
| 7-Oct | 25 | 15 | 20 | 7 | 20 | 20 |
| 8-Oct | 10 | 15 | 15 | 10 | 15 | 15 |
| 9-Oct | 10 | 10 | 10 | 7 | 10 | 10 |
| 10-Oct | 5 | 3 | 3 | 5 | 8 | 9 |
| 11-Oct | 3.5 | 3.5 | 4 | 7 | 5 | 4 |
| 12-Oct | 2 | 1 | 3 | 4 | 5 | 1 |
| 13-Oct | 0 | 0 | 3 | 3 | 0 | 0 |
| 14-Oct | 0 | 0 | 3 | 3 | 0 | 0 |
| 15-Oct | 0 | 0 | 2 | 2 | 1 | 0 |
| 16-Oct | 0 | 0 | 1 | 1 | 1 | 0 |
| 17-Oct | 0 | 0 | 0 | 1 | 0 | 0 |
| 18-Oct | 0 | 0 | 0 | 1 | 0 | 0 |
| 19-Oct | 0 | 0 | 0 | 0 | 0 | 0 |
| 20-Oct | 0 | 0 | 0 | 0 | 0 | 0 |
| 21-Oct | 0 | 0 | 0 | 0 | 0 | 0 |
| 22-Oct | 0 | 0 | 0 | 0 | 0 | 0 |
| 23-Oct | 0 | 0 | 0 | 0 | 0 | 0 |
| 24-Oct | 0 | 0 | 0 | 0 | 0 | 0 |
| 25-Oct | 0 | 0 | 0 | 0 | 0 | 0 |
| 26-Oct | 0 | 0 | 0 | 0 | 0 | 0 |
| 27-Oct | 0 | 0 | 0 | 0 | 0 | 0 |
| 28-Oct | 0 | 0 | 0 | 0 | 0 | 0 |
| 29-Oct | 0 | 0 | 0 | 0 | 0 | 0 |
| 30-Oct | 0 | 0 | 0 | 0 | 0 | 0 |
| 31-Oct | 0 | 0 | 0 | 0 | 0 | 0 |
| 1-Nov | 0 | 0 | 0 | 0 | 0 | 0 |
| 2-Nov | 0 | 0 | 1 | 0 | 0 | 0 |
| 3-Nov | 0 | 0 | 1 | 0 | 0 | 0 |
| 4-Nov | 0 | 0 | 0 | 0 | 0 | 0 |
| 5-Nov | 0 | 0 | 0 | 0 | 0 | 0 |
| 6-Nov | 0 | 0 | 5 | 0 | 0 | 0 |
| 7-Nov | 0 | 0 | 3 | 0 | 0 | 0 |
| 8-Nov | 0 | 0 | 3 | 0 | 0 | 0 |
| 9-Nov | 0 | 0 | 3 | 0 | 0 | 0 |
| 10-Nov | 0 | 0 | 4 | 0 | 0 | 0 |
| 11-Nov | 0 | 0 | 4 | 0 | 0 | 0 |
| 12-Nov | 0 | 0 | 4 | 0 | 0 | 0 |
| 13-Nov | 0 | 0 | 4 | 0 | 0 | 1 |
| 14-Nov | 0 | 0 | 5 | 0 | 0 | 2 |
| 15-Nov | 0 | 0 | 4 | 0 | 0 | 2 |
| 16-Nov | 0 | 0 | 5 D | 0 | 0 | 2 |
| 17-Nov | 0 | 0 | 3 | 0 | 0 | 5 |
| 18-Nov | 0 | 0 | 2 | 0 | 0 | 5 |
| 19-Nov | 0 | 0 | 2 | 0 | 0 | 3 |
| 20-Nov | 1 | 0 | 3 | 1 | 0 | 6 |
| 21-Nov | 4 | 4 | 25 | 4 | 3 | 15 |
| 22-Nov | 20 | 4 | 40 | 25 | 6 | 30 |
| 23-Nov | 25 | 3 | 60 | 30 | 12 | 15 |
| 24-Nov | 20 | 2 | D | 30 | 15 | 70 |
| 25-Nov | 20 | 2 | | 25 | 10 | 70 |
| 26-Nov | 15 | 3 | | 30 | 20 | 75 |
| 27-Nov | 15 | 2 | | 20 | 10 | 75 |
| 28-Nov | 8 | 2 | 0 | 20 | 10 | D |

Note “D” denotes the dumping of the contents of the pond.

The systems and methods herein may utilize DCMU in open pond systems or in closed systems such as vessels to kill or otherwise inhibit photosynthetic organisms other than Nannochloropsis. Additionally, DCMU may be utilized in conjunction with fluorescence imagining and/or detection to quantify and/or determine contamination in Nannochloropsis cultures. DCMU may also be utilized to select against photosynthetic organisms other than Nannochloropsis, so that Nannochloropsis cultures can be established from water samples containing a plurality of algal species. Further, the amino acids of positions 227-231 of the Nannochloropsis D1 protein may be changed to the evolutionarily conserved sequence to improve growth of Nannochloropsis. Finally, by changing the amino acids of a phototrophic organism's D1 protein to match the evolved moiety changes in Nannochloropsis, a photosynthetic organism may acquire heightened resistance to DCMU.

While various embodiments have been described above, it should be understood that they have been presented by way of example only, and not limitation. Thus, the breadth and scope of a preferred embodiment should not be limited by any of the above-described exemplary embodiments.

What is claimed is:

1. A method for controlling a density of algae growing in an aquatic environment, the method comprising:
applying an effective amount of 3-(3,4-dichlorophenyl)-1,1-dimethylurea (DCMU) to the density of algae growing in the aquatic environment, wherein the algae includes genus Nannochloropsis.

2. The method of claim 1, wherein the algae includes genus Tetraselmis.

3. The method of claim 1, wherein the algae includes genus Chlorella.

4. The method of claim 1, wherein applying the effective amount results in an approximate concentration of between 100 nanomolar to 1500 nanomolar DCMU in the aquatic environment.

5. The method of claim 1, wherein the aquatic environment includes seawater.

6. The method of claim 1, wherein the aquatic environment includes freshwater.

7. The method of claim 1, wherein the aquatic environment includes a mixture of seawater and freshwater.

8. The method of claim 1, wherein the effective amount of DCMU in the aquatic environment is approximately 100 nanomolar.

9. The method of claim 8, wherein the effective amount of DCMU inhibits Chlorella growth by greater than approximately 75 percent.

10. The method of claim 8, wherein the effective amount of DCMU inhibits Tetraselmis growth by greater than approximately 75 percent.

11. The method of claim 1, wherein the aquatic environment is in an open pond.

12. A method for controlling a density of algae growing in an aquatic environment, the method comprising:
applying an effective amount of DCMU to the density of algae growing in the aquatic environment, wherein the algae includes genus Nannochloropsis, wherein applying the effective amount results in an approximate concentration of between 100 nanomolar to 1500 nanomolar DCMU in the aquatic environment, and wherein the effective amount inhibits Nannochloropsis growth by no more than approximately twenty percent.

13. The method of claim 12, wherein the aquatic environment includes seawater.

14. The method of claim 12, wherein the aquatic environment includes freshwater.

15. The method of claim 12, wherein the aquatic environment includes a mixture of seawater and freshwater.

16. The method of claim 12, wherein the effective amount of DCMU inhibits Chlorella growth by greater than approximately 75 percent.

17. The method of claim 12, wherein the effective amount of DCMU inhibits Tetraselmis growth by greater than approximately 75 percent.

18. A method for controlling a density of algae growing in an aquatic environment, the method comprising:
applying an effective amount of DCMU to the density of algae growing in the aquatic environment, wherein the algae includes genus Nannochloropsis, wherein applying the effective amount results in an approximate concentration of between 0.38 micromolar to 1.55 micromolar DCMU in the aquatic environment, and wherein the effective amount inhibits Nannochloropsis growth by no more than approximately twenty percent, and wherein the effective amount of DCMU inhibits Tetraselmis growth by greater than approximately 75 percent.

19. The method of claim 18, wherein the aquatic environment includes seawater.

20. The method of claim 18, wherein the aquatic environment includes freshwater.
